(19) United States
(12) Patent Application Publication
(10) Pub. No.: US 2024/0167534 A1
(43) Pub. Date: May 23, 2024

(54) HIGH ENERGY DISSIPATION TUBE-TYPE TORSIONAL VISCOUS DAMPER AND METHODS OF TUNING A VISCOUS DAMPER USING THE VIBRATION ABSORBER PRINCIPLE

(71) Applicant: LO-REZ VIBRATION CONTROL LTD., Delta (CA)

(72) Inventors: Edward Gerald HAUPTMANN, West Vancouver (CA); Richard Andrew HORDYK, Surrey (CA)

(21) Appl. No.: 18/527,228

(22) Filed: Dec. 1, 2023

Related U.S. Application Data
(63) Continuation of application No. PCT/CA2022/050900, filed on Jun. 3, 2022.
(60) Provisional application No. 63/202,284, filed on Jun. 4, 2021.

(51) Int. Cl. F16F 15/14

(52) U.S. Cl. CPC F16F 15/1414; F16F 2222/08; F16F 2228/007; F16F 2230/0005; F16F 2230/36; F16F 2232/02; F16F 2234/02; F16F 2236/085

(57) ABSTRACT

Vibration absorbers comprising torsional viscous damper of the tube-type are tuned using one or more elastic members to improve the ability of the vibration absorbers to reduce problematic torsional vibrations. The torsional stiffness of the vibration absorbers is designed to meet a requirement between the frequency to be removed and the polar moment of inertia of the tube-type damper.

### REFERENCE TO RELATED APPLICATIONS

This application is a continuation of Patent Cooperation Treaty (PCT) application No. PCT/CA2022/050900 having an international filing date of 3 Jun. 2022 which in turn claims priority from, and for the purposes of the United States the benefit under 35 USC 119 in connection with, U.S. Patent Application No. 63/202,284 filed on 4 Jun. 2021. All of the applications referred to in this paragraph are hereby incorporated herein by reference.

### TECHNICAL FIELD

This invention relates to torsional vibration dampers. In particular, this invention relates to apparatus for tuning tubular torsional viscous dampers.

### BACKGROUND

U.S. Pat. No. 10,837,497 (Hauptmann et al.) describes a torsional viscous damper having an inertial mass in the form of a tubular member that is applicable for removing destructive torsional vibration in power transmitting shaft assemblies (a “tube-type” damper). A viscous fluid contained between the inertial mass and its outer housing is sheared, thereby producing frictional heat which is dissipated to the ambient surroundings. The torsional vibration energy is thereby removed, resulting in a corresponding reduction in torsional vibration amplitudes.

U.S. Pat. No. 4,160,390 (Spaetgens) discloses an apparatus for tuning a conventional, “disc-type” damper, wherein an inertial disc is connected to a surrounding housing with an elastic (spring) member. Spaetgens also mentions the possibility of additional tuning through an elastic connection between the damper housing and a hub attached to the driveshaft. However, Spaetgens is silent as to how this additional (hub-to-housing) tuning is to be accomplished.

There is a general desire for apparatus and methods for tuning torsional viscous dampers such as those disclosed in Hauptmann et al., for example.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a vibration absorber apparatus for a mechanical system comprising a rotating machine part. The vibration absorber apparatus comprises a tube-type torsional damper that is attached, by a hub, to the rotating machine part for rotation with the machine part about an axis of rotation, the tube-type torsional damper having a housing that is spaced apart radially from the axis, that extends circumferentially around the axis and that has a longitudinal extension having a dimension L in a longitudinal direction parallel to the axis, at least one elastic member connecting the hub to the housing for tuning the tube-type torsional damper, wherein the at least one elastic member has an effective torsional stiffness k_{T} given by k_{T}=(ω₁₁)²J, where J is an overall polar moment of inertia of the tube-type torsional damper and ω₁₁ is a resonant frequency of the mechanical system.

The at least one elastic member may comprise a disc-shaped member that extends around the axis and is disposed between, and connected to, the hub and the housing.

The disc-shaped member may be shaped to define a plurality of cut-outs, the plurality of cut-outs having the same shape, equally sized, equally radially spaced apart from the axis and equally angularly spaced apart from one another about the axis.

The disc-shaped member may be shaped to define a second plurality of cut-outs, the second plurality of cut-outs having the same shape, equally sized, equally radially spaced apart from the axis and equally angularly spaced apart from one another about the axis. The second plurality of cut-outs may have a size that is different from that of the plurality of cut-outs. The second plurality of cut-outs may have a shape that is different from that of the plurality of cut-outs. The angular spacing between the second plurality of cut-outs may be different than the angular spacing between the plurality of cut-outs. The radial spacing from the axis of the second plurality of cut-outs may be different than the radial spacing from the axis of the plurality of cut-outs.

The at least one elastic member may comprise a plurality of disc-shaped members, each disc-shaped member extending around the axis and disposed between, and connected to, the hub and the housing.

The plurality of disc-shaped members may be spaced apart from one another in the longitudinal direction.

A spacing in the longitudinal direction between an adjacent pair of the plurality of disc-shaped members may be less than the dimension L of the housing in the longitudinal direction.

The plurality of disc-shaped members may be identical to one other.

The disc-shaped member may be shaped to define one or more cut-outs with a spiral shape about the axis.

The at least one elastic member may comprise a plurality of spokes that are angularly spaced apart from one another about the axis and that extend between, and are connected to, the hub and the housing.

Each of the plurality of spokes may extend in a radial direction relative to the axis from the hub to the housing.

The spokes may be removably connected to the hub and to the housing.

The spokes may have dimensions in the longitudinal direction that are at least five times their arcuate dimension about the axis.

The spokes may have a serpentine shape as they extend between the hub and the housing.

The at least one elastic member may comprise a second plurality of spokes that are angularly spaced apart from one another about the axis and that extend between, and are connected to, the hub and the housing. The second plurality of spokes may be spaced apart from the plurality of spokes in the longitudinal direction. The plurality of spokes and the second plurality of spokes may be identical.

The at least one elastic member may be shaped to connect to the hub and to the housing at locations that are spaced apart in the longitudinal direction from one another.

The at least one elastic member may comprise one or more hub-coupling members connected to the hub at a first longitudinal direction location, one or more housing-coupling members connected to the housing at a second longitudinal direction location that is spaced apart in the longitudinal direction from the first longitudinal direction location, and a plurality of longitudinally-extending elastic members that extend between, and are connected to, the one or more hub-coupling members and the one or more housing-coupling members.

The plurality of longitudinally-extending elastic members may extend in longitudinal directions between the one or more hub-coupling members and the one or more housing-coupling members.

A torsional stiffness of the one or more hub-coupling members may be at least 10 times a torsional stiffness of the plurality of second elastic members. A torsional stiffness of the one or more housing-coupling members may be at least 10 times a torsional stiffness of the plurality of second elastic members.

The one or more hub-coupling members may comprise a plurality of spokes that are angularly spaced apart from one another about the axis and that extend from the hub in directions that have a directional component that is radial relative to the axis.

The plurality of longitudinally-extending elastic members may be connected to a corresponding one of the spokes at a location that is spaced apart from the hub in a radial direction relative to the axis.

The one or more hub-coupling members may comprise a hub-coupling ring that extends around the axis at a location that is spaced apart from the hub in a radial direction relative to the axis.

Each of the plurality of longitudinally-extending elastic members may be connected to the hub-coupling ring at a location that is spaced apart from the hub in a radial direction relative to the axis.

The one or more hub-coupling members may comprise a disc-shaped member that extends from the hub in radial directions relative to the axis.

The one or more housing-coupling members may comprise a housing-coupling ring that extends around the axis at a location that is spaced apart from the axis in a radial direction.

The at least one elastic member may comprise one or more hub-coupling members connected to the hub at a first longitudinal direction location, one or more housing-coupling members connected to the housing at a second longitudinal direction location that is spaced apart in the longitudinal direction from the first longitudinal direction location, the one or more hub-coupling members comprising a plurality of hub arms extending from the first longitudinal direction location in a first longitudinal direction, the plurality of hub arms equally angularly spaced apart from one another about the axis, the one or more housing-coupling members comprising a plurality of housing arms extending from the second longitudinal direction location in in a second longitudinal direction, the second longitudinal direction opposed to the first longitudinal direction, the plurality of housing arms equally angularly spaced apart from one another about the axis and wherein each housing arm is located at an angular location about the axis that is between a pair of hub arms, and a plurality of coil springs that extend in arcuate directions about the axis, each coil spring extending between a corresponding one of the plurality of hub arms and a corresponding one of the of the plurality of housing arms.

A torsional stiffness of the one or more hub-coupling members may be at least 10 times a torsional stiffness of the plurality of coil springs. A torsional stiffness of the one or more housing-coupling members may be at least 10 times a torsional stiffness of the plurality of coil springs.

The one or more hub-coupling members may comprise a plurality of spokes that are angularly spaced apart from one another about the axis and that extend from the hub in directions that have a directional component that is radial relative to the axis.

The plurality of hub arms may be connected to a corresponding one of the spokes at a location that is spaced apart from the hub in a radial direction relative to the axis.

The one or more hub-coupling members may comprise a hub-coupling ring that extends around the axis at a location that is spaced apart from the hub in a radial direction relative to the axis.

The plurality of hub arms may be connected to the hub-coupling ring at a location that is spaced apart from the hub in a radial direction relative to the axis.

The one or more hub-coupling members may comprise a disc-shaped member that extends from the hub in radial directions relative to the axis.

The one or more housing-coupling members may comprise a housing-coupling ring that extends around the axis at a location that is spaced apart from the axis in a radial direction.

Another aspect of the invention provides a vibration absorber apparatus for a mechanical system comprising a rotating machine part. The vibration absorber apparatus comprises a tube-type torsional damper that is attached, by a hub, to the rotating machine part for rotation with the machine part about an axis of rotation, the tube-type torsional damper having a housing that is spaced apart radially from the axis, that extends circumferentially around the axis and that has a longitudinal extension having a dimension L in a longitudinal direction parallel to the axis, at least one elastic member connecting the hub to the housing for tuning the tube-type torsional damper, the at least one elastic member shaped to connect to the hub and to the housing at locations that are spaced apart in the longitudinal direction from one another.

The at least one elastic member may comprise one or more hub-coupling members connected to the hub at a first longitudinal direction location, one or more housing-coupling members connected to the housing at a second longitudinal direction location that is spaced apart in the longitudinal direction from the first longitudinal direction location, and a plurality of longitudinally-extending elastic members that extend between, and are connected to, the one or more hub-coupling members and the one or more housing-coupling members.

The plurality of longitudinally-extending elastic members may extend in longitudinal directions between the one or more hub-coupling members and the one or more housing-coupling members.

A torsional stiffness of the one or more hub-coupling members may be at least 10 times a torsional stiffness of the plurality of longitudinally-extending elastic members. A torsional stiffness of the one or more housing-coupling members may be at least 10 times a torsional stiffness of the plurality of longitudinally-extending elastic members.

The one or more hub-coupling members may comprise a plurality of spokes that are angularly spaced apart from one another about the axis and that extend from the hub in directions that have a directional component that is radial relative to the axis.

The plurality of longitudinally-extending elastic members may be connected to a corresponding one of the spokes at a location that is spaced apart from the hub in a radial direction relative to the axis.

The one or more hub-coupling members may comprise a hub-coupling ring that extends around the axis at a location that is spaced apart from the hub in a radial direction relative to the axis.

Each of the plurality of longitudinally-extending elastic members may be connected to the hub-coupling ring at a location that is spaced apart from the hub in a radial direction relative to the axis.

The one or more hub-coupling members may comprise a disc-shaped member that extends from the hub in radial directions relative to the axis.

The one or more housing-coupling members may comprise a housing-coupling ring that extends around the axis at a location that is spaced apart from the axis in a radial direction.

Another aspect of the invention provides a method for damping vibrations in a mechanical system comprising a rotating machine part. The method comprises providing a tube-type torsional damper that is attached, by a hub, to the rotating machine part for rotation with the machine part about an axis of rotation, the tube-type torsional damper having a housing that is spaced apart radially from the axis, that extends circumferentially around the axis and that has a longitudinal extension having a dimension L in a longitudinal direction parallel to the axis, connecting at least one elastic member to the hub and to the housing, wherein the at least one elastic member has an effective torsional stiffness k_{T} given by k_{T}=(ω₁₁)²J, where J is an overall polar moment of inertia of the tube-type torsional damper and ω₁₁ is a resonant frequency of the mechanical system.

The method may comprise method steps or features corresponding to any of the features recited above or elsewhere herein.

Another aspect of the invention provides a method for damping vibrations in a mechanical system comprising a rotating machine part. The method comprises providing a tube-type torsional damper that is attached, by a hub, to the rotating machine part for rotation with the machine part about an axis of rotation, the tube-type torsional damper having a housing that is spaced apart from the axis, that extends circumferentially around the axis and that has a longitudinal extension having a dimension L in a longitudinal direction parallel to the axis, connecting at least one elastic member to the hub and to the housing, wherein connecting the at least one elastic member to the hub and to the housing comprises connecting the at least one elastic member to the hub and to the housing at locations that are spaced apart in the longitudinal direction from one another.

The method may comprise method steps or features corresponding to any of the features recited above or elsewhere herein.

In addition to the exemplary aspects and embodiments described above, further aspects and embodiments will become apparent by reference to the drawings and by study of the following detailed descriptions. It is emphasized that the invention relates to all combinations and sub-combinations of the above features and other features described herein, even if these are recited in different claims or claims with different dependencies.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of an inertia tube of a tube-type damper.

FIG. 2 is a partial cross-section view of the FIG. 1 tube-type damper.

FIG. 3 is a partial cross-sectional view of a tube-type damper according to another embodiment.

FIG. 4 is a model simulation graph of the amplitude vs excitation (vibrational) frequency response of an un-tuned, un-damped rotating system.

FIG. 5 is a model simulation graph of the amplitude vs excitation (vibrational) frequency response of the FIG. 4 rotational system tuned with the addition of a spring mass system.

FIG. 6 is a model simulation graph of the amplitude vs excitation (vibrational) frequency response of FIG. 4 rotational system tuned with the addition of a spring mass system and a disc-type damper.

FIG. 7 is a graph of a torsional amplitude vs excitation frequency for an example engine with and without a tuned damper.

FIG. 8 is an exploded perspective view of a mechanical system comprising a rotating shaft and a vibration absorber comprising a tube-type damper and one or more elastic members for tuning the damper according to a particular embodiment, wherein the one or more elastic members comprise a plurality of spokes extending between a hub and a housing of the tube-type damper.

FIG. 9A is a perspective cross-section view of a vibration absorber comprising a tube-type damper and one or more elastic members for tuning the damper according to a particular embodiment, wherein the one or more elastic members comprise a disc-shaped member extending between the hub and the housing.

FIG. 9B is a perspective view of the FIG. 9A vibration absorber according to a particular embodiment wherein a plurality of cut-outs have been formed in the disc-shaped member to reduce torsional stiffness.

FIG. 9C is a front plan view of an exemplary disc-shaped member according to another embodiment in which an array of cut-outs of differing size have been formed to reduce torsional stiffness while evenly distributing stresses.

FIG. 9D is a front plan view of an exemplary disc-shaped member according to another embodiment in which two spiral shaped cut-outs have been formed to reduce torsional stiffness.

FIG. 10A is a front plan view of a vibration absorber comprising a tube-type damper and one or more elastic members for tuning the damper according to a particular embodiment, wherein the one or more elastic members comprise a plurality of thin spokes extending between the hub and the housing of the tube-type damper.

FIG. 10B is a perspective view of the FIG. 10A vibration absorber.

FIG. 11 is a front plan view of a vibration absorber comprising a tube-type damper and one or more elastic members for tuning the damper according to a particular embodiment, wherein the one or more elastic members comprise a plurality of serpentine elements extending between the hub and the housing of the tube-type damper.

FIG. 12A is a perspective view of a vibration absorber comprising a tube-type damper and one or more elastic members for tuning the damper according to another particular embodiment.

FIG. 12B is a perspective view of the FIG. 12A vibration absorber with the tube-type damper removed.

FIG. 12C is a cross-section view of the elastic member of FIGS. 12A, 12B, taken along a mid plane;

FIG. 13 is a perspective view of a vibration absorber comprising a tube type damper and one or more elastic members for tuning the damper according to a particular embodiment, wherein the one or more elastic members comprise a plurality of circumferentially oriented coil springs extending between the hub and the housing of the tube-type damper with a portion of the housing removed.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

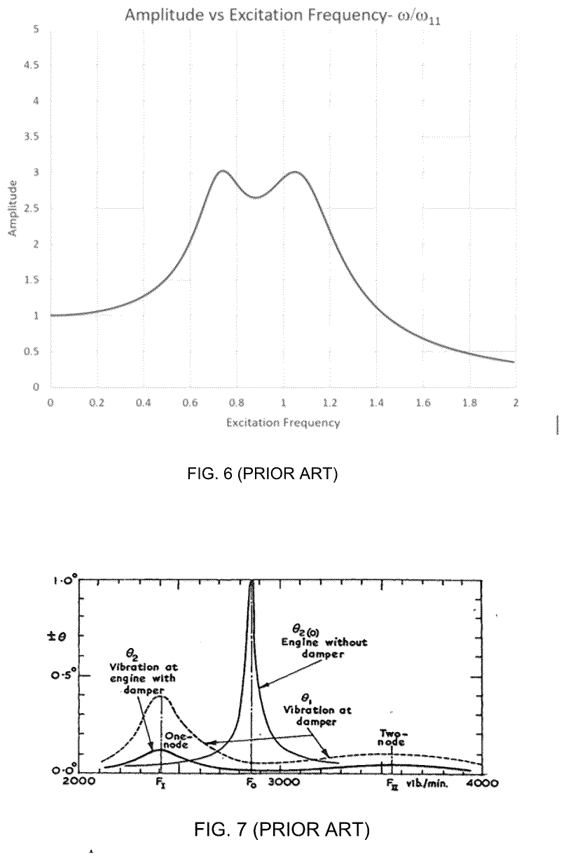

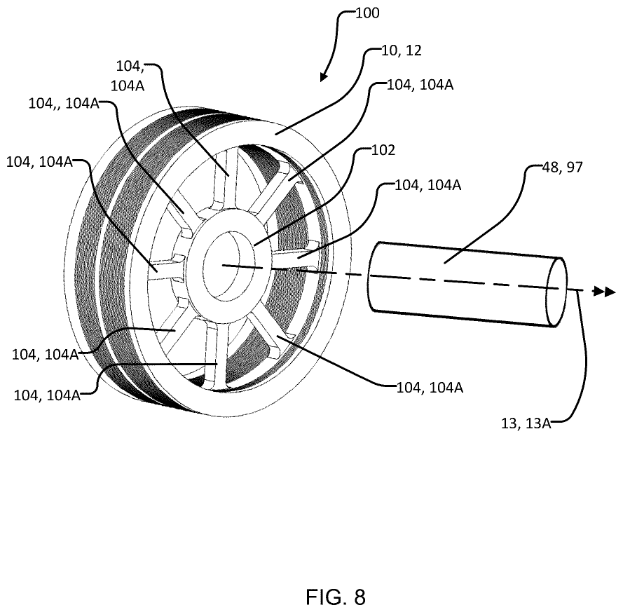

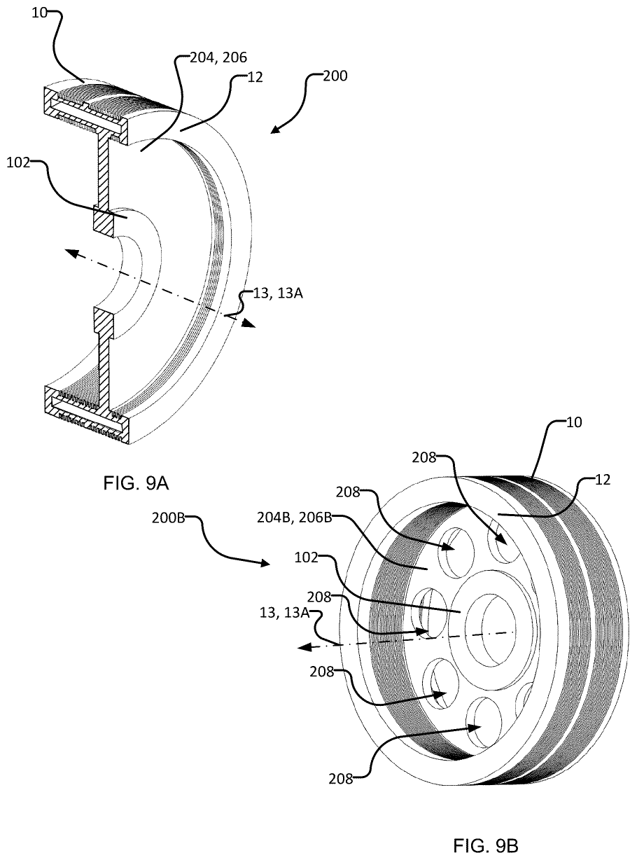

It is known generally to tune and to damp rotational systems to address vibration. FIGS. 4 and 5 show model simulations that illustrate the effect of “tuning” a rotational system with an added spring mass system. Specifically, FIG. 4 shows vibrational amplitude versus frequency of an undamped rotational system and FIG. 5 shows vibrational amplitude versus frequency of the same undamped rotational system tuned with the addition of a spring mass system tuned to the resonant frequency (ω₁₁) of the mechanical system. In FIG. 4, the undamped rotational system can have unlimited vibrational amplitude at the resonant frequency (ω₁₁). FIG. 5 illustrates that the undamped rotational system can be tuned by the addition of a spring mass system which exactly cancels out the resonant peak to provide a local minimum of the vibrational amplitude at the resonant frequency ω₁₁. However, the added spring mass system creates two new resonant peaks on each side of the tuned vibrational minimum at ω₁₁. FIG. 6 shows the effect of adding both a spring mass system and a disc-type damper (of the type described in Spaetgens) to the FIG. 4 system. Comparing FIGS. 4, 5 and 6, it can be observed that the addition of a damper (in FIG. 6) significantly reduces the amplitude of the two resonant peaks introduced by tuning (FIG. 5) while still permitting cancellation of the untuned and undamped resonant peak (FIG. 4).

Looking more closely at FIG. 6, it can be observed that with the addition of damping, the tuning frequency (the frequency of the local minima between the two maxima created by tuning) is lower than the undamped tuning frequency ω₁₁ shown in FIG. 5. This effect illustrates that finding optimal damping and tuning for maximum vibrational amplitude reduction is an iterative process.

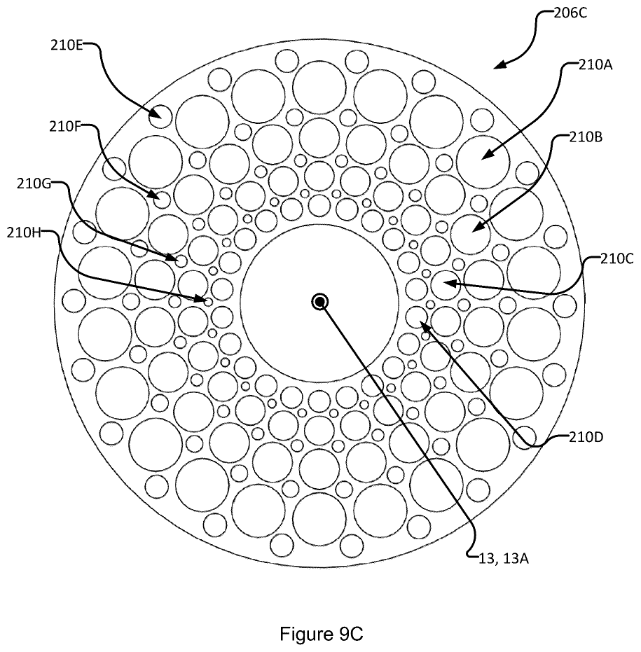

FIG. 7 is a graph of a torsional amplitude vs excitation frequency for an example engine with and without a tuned damper. Apart from the effect of the damper, FIG. 7 shows that “tuning” the system provides substantial additional amplitude reduction.

The inventors have determined that using the principles of tuning out problematic natural frequencies might also be used to improve the performance of “tube” type dampers, such as those described in U.S. Pat. No. 10,837,497 (Hauptmann et al.), which is hereby incorporated herein by reference.

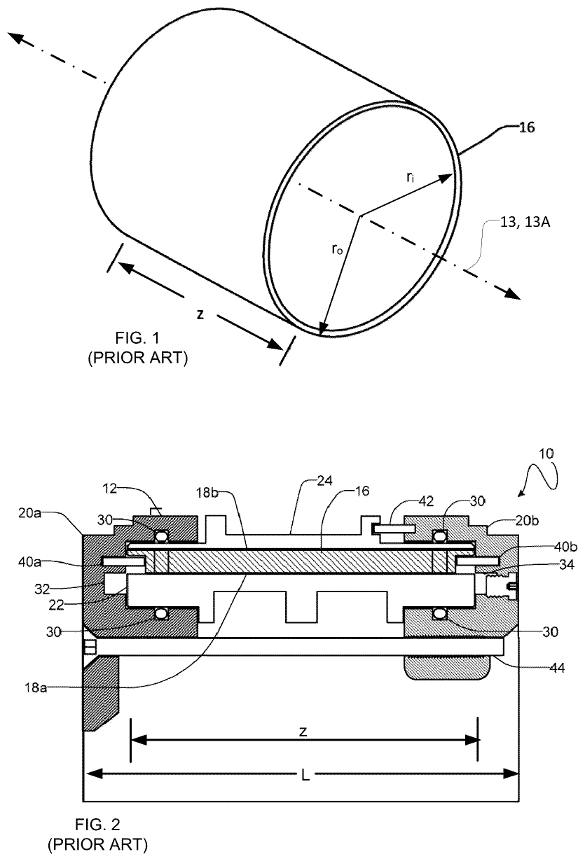

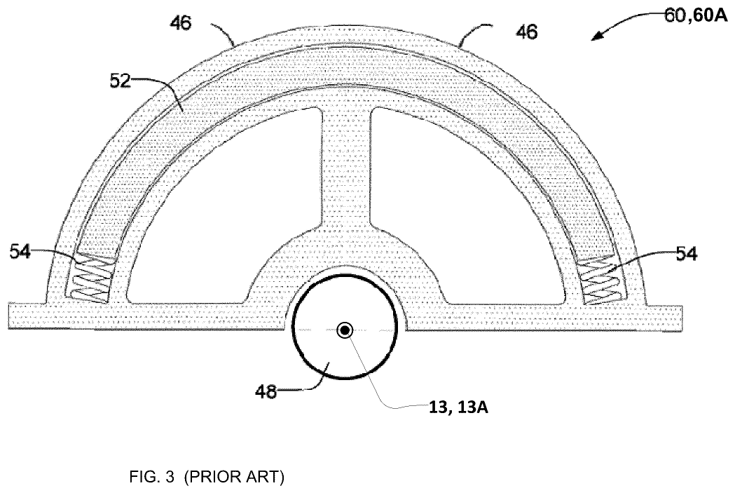

Referring to FIGS. 1 and 2, a “tube” type damper 10 may comprise a tubular inertial mass or inertia tube 16 having a longitudinal length z in an axial/longitudinal direction (illustrated by double-headed arrow 13), an inner radius rᵢ, and an outer radius rₒ. Inertia tube 16 is mounted to rotate within and relative to a housing 12 that provides surfaces spaced apart from inside and outside walls of the inertia tube 16 by gaps 18A, 18B, containing a viscous fluid. The viscous fluid may, for example, comprise siloxane or silicone. Housing 12 may be attached or mounted to a rotating member (not shown in FIG. 1 or 2) of a machine or mechanical system (e.g. a rotating shaft) having an axis of rotation 13A that extends in longitudinal/axial direction 13. Throughout this disclosure, “longitudinal” refers to a direction that is substantially parallel to axis of rotation 13A. “Axial” refers to a direction substantially aligned with axis of rotation 13A. “Radial” refers to a direction extending substantially orthogonally from axis of rotation 13A. “Circumferential” refers to a direction that is substantially tangential to a circle concentric with axis of rotation 13A.

Inertia tube 16 is concentric with and rotatable about axis of rotation 13A and extends longitudinally (in direction 13) along axis of rotation 13A. Inertia tube 16 is viscously coupled to rotate with housing 12.

Inertia tube 16 may be characterized by one or more of the following:
having a radial thickness, r₀-rᵢ, that is less than one tenth of the outer radius rₒ;
having a length, z, in longitudinal direction 13 that is greater than the radial thickness, rₒ-rᵢ;

Referring to FIG. 2, tube-type damper 10 comprises first and second end caps 20a and 20b which form the ends of housing 12. Inner housing part 22 and outer housing part 24 of housing 12 are supported at their axial ends by end caps 20a, 20b with inner housing part 22 located radially inwardly (relative to axis 13A) of outer housing part. Inertia tube 16 fits radially (relative to axis 13A) between inner housing part 22 and outer housing part 24.

The clearance between inertia tube 16 and each of inner housing part 22 and outer housing part 24 forms inner and outer gaps 18a and 18b respectively. When viscous damper 10 is assembled, inner and outer gaps 18a and 18b are filled with a viscous fluid, such as siloxane, silicone and/or the like. Seals, such as O-rings 30, retain the fluid. For example, O-rings 30 fit into slots between inner and outer housing parts 22, 24 and end cap 20a and between inner and outer housing parts 22, 24 and end cap 20b. O-rings 30 assist in preventing leaking of high-viscosity fluid from between end caps 20a, 20b and housing parts 22, 24. Bearings 40a and 40b may be provided between the axial ends of inertia tube 16 and respective end caps 20a, 20b.

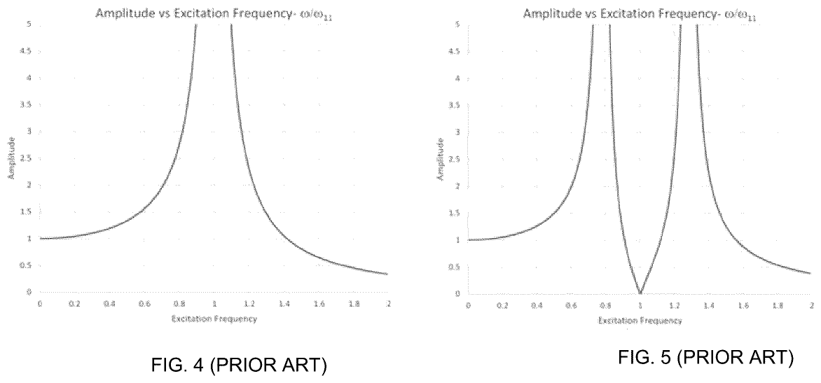

FIG. 3 is a partial cross-sectional view of a tube-type damper 60 according to another embodiment. Referring to FIG. 3, tube-type damper 60 comprises a pair of damper halves 60A (only one of which is shown in the FIG. 3 partial view) which clamp around a shaft 48 which extends in an axial/longitudinal direction 13 (into and out of the page in the FIG. 3 view) for rotation about axis 13A. Each damper half 60A of the FIG. 3 damper 60 comprises a semi-cylindrical housing 46 in which an inertia half-tube 52 and a viscous fluid (such as siloxane, silicone and/or the like) are disposed. Inertia half-tube 52 is capable of limited rotation about axis 13A within housing 46. Springs 54 may optionally be coupled between the circumferential (longitudinally extending) ends of inertia half-tube 52 and semi-cylindrical housing 46. Springs 54 may exert a restoring force on inertia half-tube 52 when inertia half-tube 52 partially rotates about axis 13A relative to semi-cylindrical housing 46 away from a neutral position to provide a damping effect and to keep inertia half tube 52 centered in housing 46. In some embodiments, springs 54 may provide tuning between housing 46 and inertia half-tube 52.

Aspect of various embodiments of the invention provide vibration absorbers comprising tube-type dampers like tube-type damper 10 (of FIGS. 1 and 2), tube-type damper 60 (of FIG. 3) and/or the like and one or more elastic members for tuning the tube-type damper. For ease of discussion, vibration absorbers according to various embodiments of the invention are described herein as comprising tube-type damper 10 without loss of generality that such vibration absorbers could comprise other tube-type dampers.

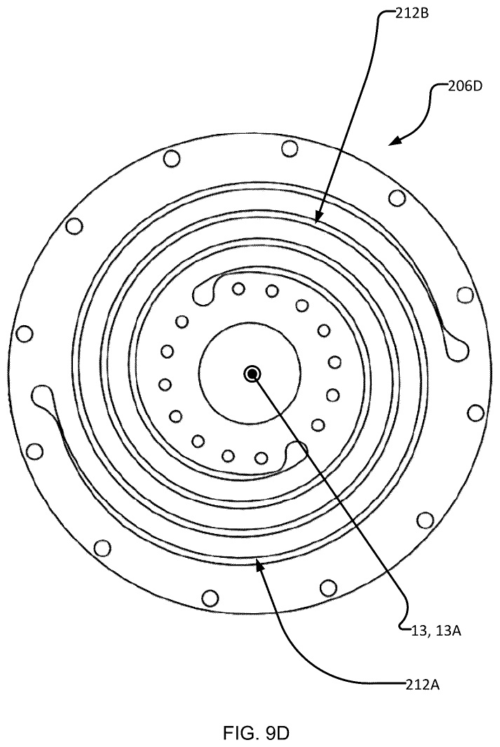

FIG. 8 is a partial perspective view of a rotational system 97 (as represented by rotating shaft 48) which is being tuned with a vibration absorber 100 according to a particular embodiment. Vibration absorber 100 of the FIG. 8 embodiment comprises a tube-type damper 10 and one or more elastic members 104 for tuning tube-type damper 10. The one or more elastic members 104 extend between, and are connected to, housing 12 of tube-type damper 10 and a hub 102. Hub 102 is fixedly coupled to a rotating machine part, such as shaft 48, of mechanical system 97 for rotation about axis 13A. In the illustrated embodiment of FIG. 8, the one or more elastic members 104 of vibration absorber 100 comprise a plurality of spokes 104A which extend between and are connected to housing 12 and hub 102, which are angularly spaced apart from one another (e.g. equally angularly spaced apart from one another) about axis 13A, which are aligned with one another in longitudinal/axial direction 13 and which extend generally radially relative to axis 13A. These characteristics of spokes 104A are not necessary. The locations, sizes, shapes and/or material compositions of spokes 104A may additionally or alternatively be varied to meet the equation (1) torsional stiffness criteria (explained in more detail below).

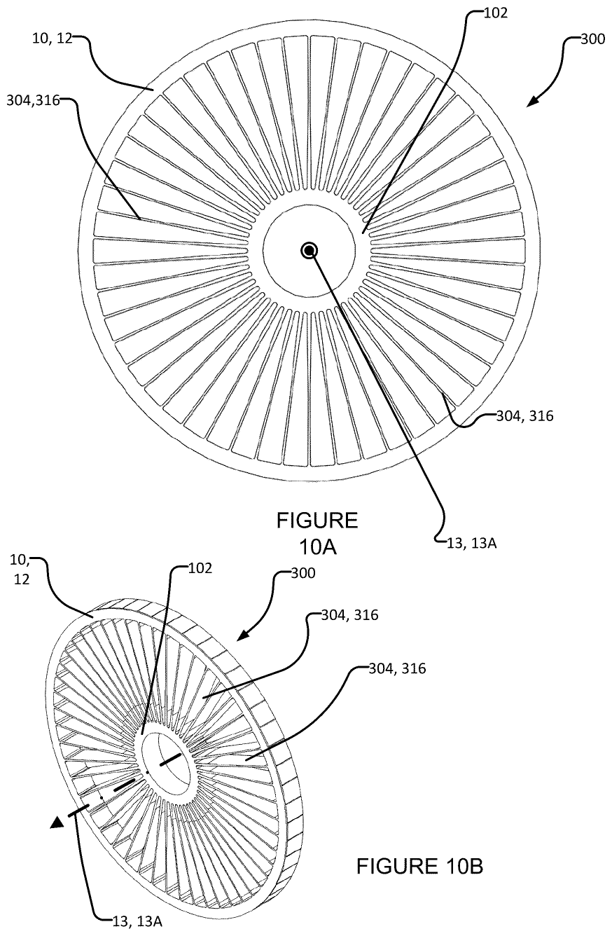

FIG. 9A is a partial perspective view of a vibration absorber 200 comprising a tube-type damper 10 and one or more elastic members 204 for tuning tube-type damper 10 according to another particular embodiment of the invention. The one or more elastic members 204 extend between, and are connected to, housing 12 of tube-type damper 10 and a hub 102 configured to be fixedly coupled to a rotating machine part of a mechanical system, such as a shaft (not shown) for rotation about axis 13A. In the illustrated FIG. 9A embodiment, elastic member(s) 204 of vibration absorber 200 comprise one or more disc-shaped members 206 (only one of which is shown in the FIG. 9A illustrated embodiment). In general, disc-shaped members 206 may be generally annularly shaped about axis 13A and, in embodiments comprising a plurality of disc-shaped members 206, may be longitudinally spaced apart from (and/or abutting against) one another in longitudinal/axial direction 13.

Vibration absorbers 100, 200 may be “tuned” (i.e. to provide tuning to tube-type damper 10) in a manner which is not contemplated in previous tube-type damper designs.

In particular embodiments, vibration absorbers 100, 200 are tuned by designing their corresponding elastic members 104, 204 to have an effective (combined) torsional stiffness k_{T} [Nm/rad] given by:

k_{T}=(ω₁₁)²J (1)

where J [kgm²] is an overall polar moment of inertia of tube-type torsional damper 10 and ω₁₁ is the problematic or resonant frequency of the mechanical system (absent vibration absorber 100, 200). As discussed above in connection with FIG. 6, with damping, the “tuning” frequency ω₁₁ is slightly lower than the undamped tuning frequency and finding the optimum damping and tuning for maximum amplitude reduction is an iterative process.

In general, the combined torsional stiffness k_{T} of the one or more elastic members 104, 204 of vibration absorbers 100, 200 can be controlled to meet the equation (1) criteria by varying a number of physical parameters, such as: the material composition (and corresponding elasticity) of elastic members 104, 204, the physical dimensions of (and corresponding elasticity) of elastic members 104, 204, locations of elastic members 104, 204, spacing between elastic members 104, 204, a number of elastic members 104, 204 and/or the like. For example, in the case of the FIG. 8 vibration absorber 100, the combined torsional stiffness k_{T} of the one or more elastic members 104 can be controlled to meet the equation (1) criteria by varying the material composition (and corresponding elasticity) of spokes 104A, the physical dimensions of (and corresponding elasticity) of spokes 104A, locations of spokes 104A, spacing between spokes 104A, a number of spokes 104A and/or the like. By way of similar example, in the case of the FIG. 9A vibration absorber 200, the torsional stiffness k_{T} of the one or more elastic members 204 can be controlled to meet the equation (1) criteria by varying the material composition (and corresponding elasticity) of disc-shaped members 206, the physical dimensions of (and corresponding elasticity) of disc-shaped members 206, locations of disc-shaped members 206, spacing between disc-shaped members 206, a number of disc-shaped members 206 and/or the like.

FIG. 9B shows a variation 200B of the FIG. 9A vibration absorber 200, wherein disc-shaped member(s) 206B are shaped to provide one or more cut-outs 208 that penetrate in the longitudinal direction 13 through disk-shaped member(s) 206B. In the illustrated embodiment, cut-outs 208 are circularly shaped, located at evenly spaced apart angles about axis 13A and have the same size, but these characteristics are not necessary provided that cut-outs 208 are overall rotationally symmetric about axis 13A, so as to avoid rotational imbalances. The locations, sizes and/or shapes of such cut-outs 208 may additionally or alternatively be varied to meet the equation (1) torsional stiffness criteria. In other respects, vibration absorber 200B of FIG. 9B is similar to vibration absorber 200 of FIG. 9A and, except where the context dictates otherwise, discussion herein relating to the FIG. 9A vibration absorber 200 (and/or its components) should be considered to apply to the FIG. 9B vibration absorber 200B.

FIG. 9C shows a front plan view of a disc-shaped member 206C according to a particular embodiment which is suitable for use as an elastic member 204 in vibration absorber 200. Disc-shaped member 206C of the FIG. 9C embodiment is shaped to provide a number of cut-outs 210A-210H of varying size. In the illustrated embodiment of FIG. 9C, cut-outs 210A-210H are circularly shaped, are designed such that cut-outs 210A-201H located at the same radius (relative to axis 13A) have the same size, are designed such that cut-outs 210A-201H located at the same radius (relative to axis 13A) are located at evenly spaced apart angles about axis 13A and are designed such that cut-outs on any particular radial line (relative to axis 13A) decrease in size from a larger radius (relative to axis 13A) to a smaller radius (relative to axis 13A). Advantageously, these characteristics may distribute stresses circumferentially symmetrically (about axis 13A) and radially (relative to axis 13A), but these characteristics are not necessary provided that cut-outs 210A-210H are overall rotationally symmetric about axis 13A. The locations, sizes and shapes of such cut-outs 210A-210H may additionally or alternatively be varied to meet the equation (1) torsional stiffness criteria. In other respects, disc-shaped member 206C of FIG. 9C is similar to disc-shaped members 206 of FIGS. 9A and 206B of FIG. 9B. Except where the context dictates otherwise, discussion herein relating to disc-shaped members 206 of FIGS. 9A and 206B of FIG. 9B should be considered to apply to the FIG. 9C disc-shaped member 206C. Further, as discussed above, disc shaped member 206C is suitable for use with vibration absorber 200 and, unless the context dictates otherwise, discussion herein relating to vibration absorber 200 should be considered to include the possible use of disc-shaped member 206C.

FIG. 9D shows a front plan view of a disc-shaped member 206D according to a particular embodiment which is suitable for use as an elastic member 204 in vibration absorber 200. Disc-shaped member 206D of the FIG. 9D embodiment is shaped to provide at least one (e.g. two) spiral-shaped cut-outs 212A, 212B (collectively, spiral-shaped cut-outs 212). Spiral-shaped cut-outs 212 may have spiral shapes about axis 13A, although this is not necessary. The number, locations, sizes and shapes of spiral-shaped cut-outs 212 may additionally or alternatively be varied to meet the equation (1) torsional stiffness criteria. Depending on their sizes and shapes, spiral-shaped cut-outs 212 may provide disc-shaped member 206D with relatively low torsional stiffness k_{T} (compared to other disc-shaped members 206 described above). In other respects, disc-shaped member 206D of FIG. 9D is similar to disc-shaped members 206 of FIGS. 9A and 206B of FIG. 9B. Except where the context dictates otherwise, discussion herein relating to disc-shaped members 206 of FIGS. 9A and 206B of FIG. 9B should be considered to apply to the FIG. 9D disc-shaped member 206D. Further, as discussed above, disc-shaped member 206D is suitable for use with vibration absorber 200 and, unless the context dictates otherwise, discussion herein relating to vibration absorber 200 should be considered to include the possible use of disc-shaped member 206D.

In general, for higher values of the problematic torsional frequency ω₁₁, it will be recognized that elastic members 104, 204 of vibration absorbers 100, 200 must have a higher torsional stiffness k_{T} in accordance with the equation (1) relationship described above. In addition to torsional stiffness (k_{T}), another mechanical design factor to be considered is the working stress in elastic members 104, 204. The stiffness and working stress level are opposing design objectives; stiffer elastic members 104, 204 will generally experience lower working stresses, while lower stiffness elastic members 104, 204 will generally experience higher working stresses. Designing elastic members 104, 204 to have low stiffness while carrying low or moderate working stresses presents a design challenge.

To illustrate these design challenges, consider vibration absorbers 200, 200B shown in FIGS. 9A and 9B. Cut-outs 208 formed in disc-shaped member 206B of vibration absorber 200B will tend to lower the torsional stiffness kₜ of elastic member 204B (as compared with elastic member 204), but will thereby also increase the average working stress experienced by elastic member 204B (as compared with elastic member 204).

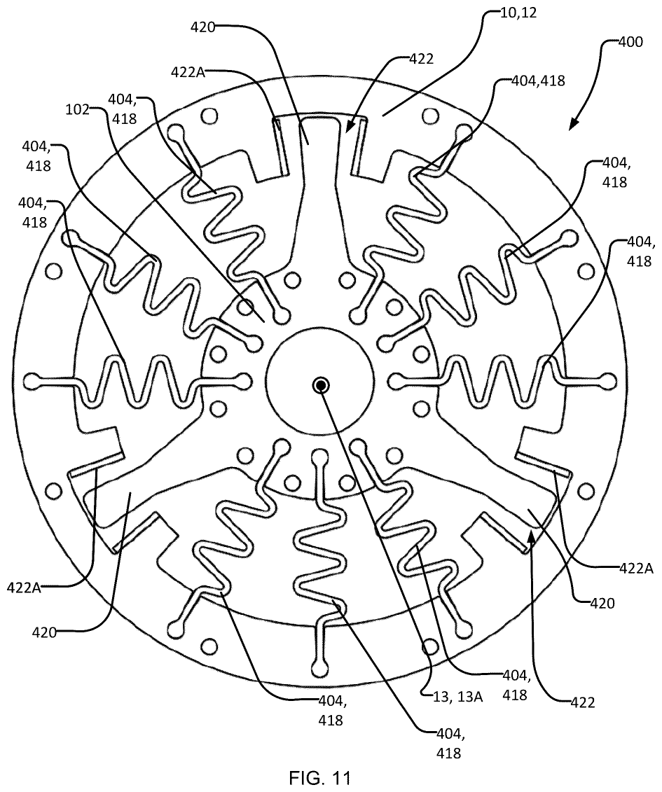

FIGS. 10A and 10D (together, FIG. 10) show a vibration absorber 300 comprising a tube-type damper 10 and one or more elastic members 304 for tuning tube-type damper 10 according to another particular embodiment of the invention. The one or more elastic members 304 extend between, and are connected to, housing 12 of tube-type damper 10 and hub 102 configured to be fixedly coupled to a rotating machine part, such as a shaft (not shown) for rotation about axis 13A. Like vibration absorber 100 of the FIG. 8 embodiment, in the illustrated FIG. 10 embodiment, elastic members 304 of vibration absorber 300 comprise spokes 316 which are angularly spaced apart from one another about axis 13A, which are aligned with one another in longitudinal/axial direction 13 and which extend generally radially relative to axis 13A. In contrast to spokes 104A of vibration absorber 100, spokes 316 of vibration absorber 300 are relatively thin in the circumferential direction about axis 13A and may be relatively thicker in the longitudinal direction 13 (i.e. strip-shaped). The locations, sizes, shapes and/or material composition of spokes 316 may additionally or alternatively be varied to meet the equation (1) torsional stiffness criteria. Spokes 316 of vibration absorber 300 may be removable (or addable to vibration absorber 300) to allow the torsional stiffness kₜ of elastic member(s) 304 to be modified by adding or removing spokes 316 as desired. In some embodiments, several elastic members 304 (each comprising a corresponding plurality of spokes 316) may be provided between hub 102 and housing 12 at locations that are spaced apart from (and/or abutting against) one another in longitudinal direction 13. In other respects, vibration absorber 300 of FIG. 10 is similar to vibration absorbers 100, 200 of FIGS. 8, 9A and, except where the context dictates otherwise, discussion herein relating to vibration absorbers 100, 200 of FIGS. 8, 9A should be considered to apply to the FIG. 10 vibration absorber 300.

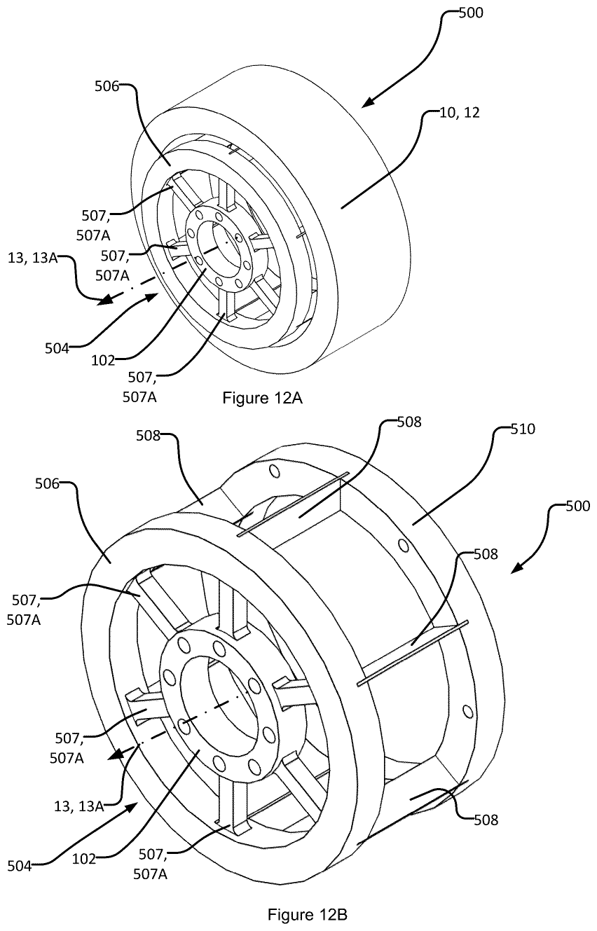

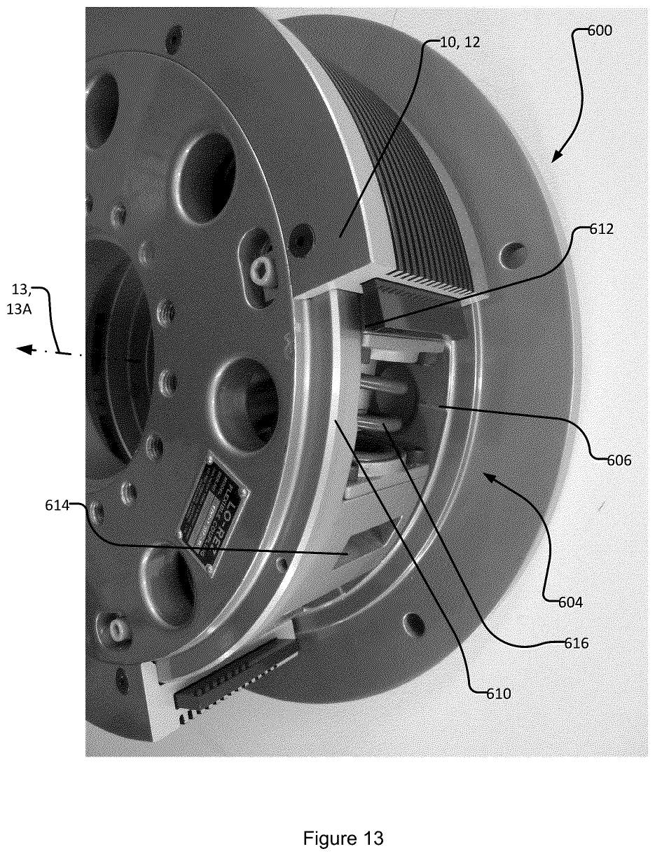

FIG. 11 is a vibration absorber 400 comprising a tube-type damper 10 and one or more elastic members 404 for tuning tube-type damper 10 according to another particular embodiment of the invention. Elastic members 404 extend between, and are connected to, housing 12 of tube-type damper 10 and a hub 102 configured to be fixedly coupled to a rotating machine part, such as a shaft (not shown) for rotation about axis 13A. In the illustrated FIG. 13 embodiment, elastic members 404 comprise a plurality of serpentine elements 418 connecting hub 102 to housing 12 of damper 10 (i.e. spokes having a serpentine shape as they extend between hub 102 and housing 12). Serpentine elements 418 may be metallic or made from a composite fibre material. Serpentine elements 418 of the illustrated embodiment extend radially between hub 102 and housing 12 at locations that are evenly angularly distributed about axis 13A (although this is not necessary, provided that serpentine elements 218 are distributed in a rotationally symmetric manner). The locations, size, shape and material compositions of serpentine elements 418 may additionally or alternatively be varied to meet the equation (1) torsional stiffness criteria. In the FIG. 11 embodiment, vibration absorber 400 further comprises a plurality of radially extending arms 420 evenly spaced apart about axis 13A that may be integral with or otherwise mounted to hub 102. Vibration absorber 400 of the FIG. 11 embodiment also comprises a plurality of channels 422 that may be integral with or otherwise mounted to housing 12 and positioned such that arms 420 extend radially outward from axis 13A into channels 422. Channels 422 are defined by angularly spaced apart sidewalls 422A, which act to limit the amount of relative twist between hub 102 and housing 12 by preventing arms 420 from rotating (about axis 13A) past sidewalls 422A of channels 422. Vibration absorber 400 has been found to be suitable in some applications requiring moderate torsional stiffness kₜ and moderate stress. In other respects, vibration absorber 400 of FIG. 11 is similar to vibration absorbers 100, 200 of FIGS. 8, 9A and, except where the context dictates otherwise, discussion herein relating to vibration absorbers 100, 200 of FIGS. 8, 9A should be considered to apply to the FIG. 11 vibration absorber 400.

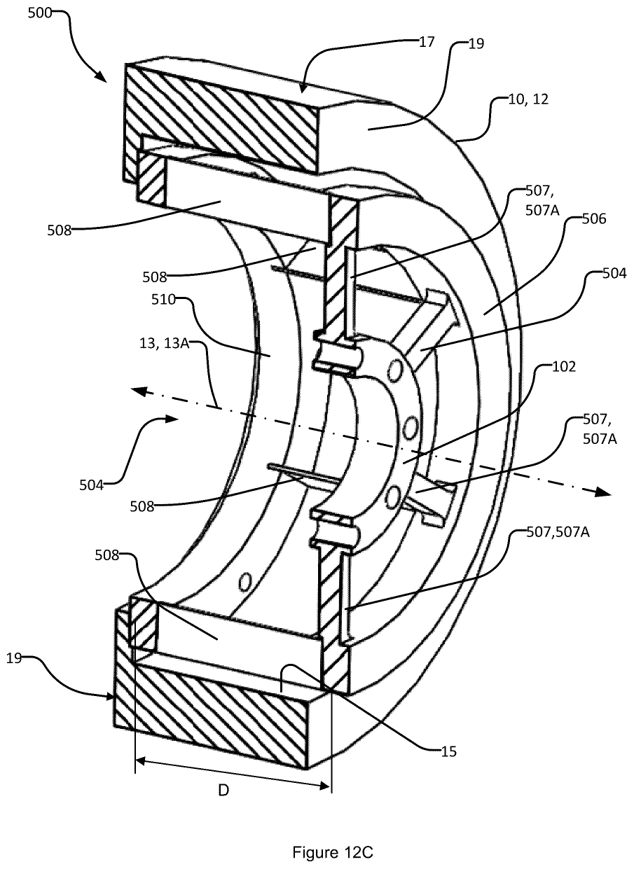

Many modern, high-speed reciprocating compressors have problematic natural frequencies, typically in the 50 to 80 Hz range. The above-discussed vibration absorbers 100, 200, 300, 400 having elastic members with the desired (equation (1)) torsional stiffness kₜ to dampen these problematic natural frequencies, that is, relatively low torsional stiffness kₜ, would be correspondingly highly stressed. Elastic members 104, 204, 304, 404 of vibration absorbers 100, 200, 300, 400 extend between hub 102 and housing 12 in predominantly the radial direction. That is, connection of elastic members 104, 204, 304, 4040 to hub 102 and to housing 12 is substantially planar. However, tube-type dampers 10 have a longitudinal-direction length L (see FIGS. 2 and 12A). This longitudinal-direction length L of tube-type dampers 10 is somewhat greater than the longitudinal-direction length z of inertia tube 12 (see FIG. 1). Accordingly, the inventors have found that tube-type dampers 10 may be tuned using elastic members having shapes that extend in axial/longitudinal direction 13 (e.g. along the axial/longitudinal-direction length L of tube-type dampers 10), that is, with at least some components extending in axial/longitudinal direction 13. Stated another way, attachment of the elastic members to housing 12 need not be planar with hub 102 but can be longitudinally offset along length L from hub 102.

As described above, some embodiments may comprise a plurality of elastic members of the types described above which may be spaced apart from (and/or abutting against) one another along axial/longitudinal direction 13 (e.g. along the length L of tube-type damper 10).

FIGS. 12A, 12B and 12C (collectively, FIG. 12) depict various views of a vibration absorber 500 comprising a tube-type damper 10 and one or more elastic members 504 for tuning tube-type damper 10 according to another embodiment. Elastic member 504 of the illustrated FIG. 12 embodiment comprises: one or more hub-coupling members 507, hub-coupling ring 506, longitudinally-extending elastic members 508 and one or more housing-coupling members 510. Hub-coupling members 507 connect to hub 102. Hub-coupling members 507 of the FIG. 12 embodiment comprise a plurality of stiffened spokes 507A that extend radially (relative to axis 13A) outward from hub 102. Stiffened spokes 507A of the illustrated embodiment terminate in a hub-coupling ring 506. A plurality of cantilever spring elements (longitudinally-extending elastic members) 508 extend longitudinally from hub coupling ring 506 in longitudinal directions 13 parallel to (or with directional components parallel to) axis 13A of rotation and connect hub coupling ring 506 to one or more housing-coupling members (in the FIG. 12 embodiment, a housing-coupling ring) 510. Housing-coupling members 510 connect to housing 12 at location(s) which are longitudinally spaced apart from location(s) that hub-coupling members 507 connect to hub 102. In the illustrated embodiment, housing-coupling ring 510 is mounted to an interior surface 15 of housing 12 of tube-type damper 10. Accordingly, the location at which elastic member 504 is mounted or connected to hub 102 is spaced apart (in longitudinal direction 13) from the location at which elastic member 504 is mounted or connected to housing 12 of tube type damper 10, as indicated by dimension D in FIG. 12C.

In some embodiments, hub coupling ring 506 may be omitted and cantilever spring elements (longitudinally-extending elastic members) 508 may extend in longitudinal directions 13 (or with directional components that extend in longitudinal directions 13) directly from each of the stiffened spokes 507A. Housing-coupling component(s) (e.g. housing-coupling) ring 510 may be mounted to an interior surface 15 of housing 12 as shown in the illustrated embodiment. In other embodiments, housing-coupling component(s) 510 may be mounted to an outer surface 17 of housing 12 or to a longitudinally-facing edge 19 of housing 12. In these other embodiments, the location at which elastic member 504 is mounted or connected to hub 102 is spaced apart (in longitudinal direction 13) from the location at which elastic member 504 is mounted or connected to housing 12 of tube type damper 10.

In some embodiments, longitudinally-extending cantilever spring elements (longitudinally-extending elastic members) 508 are thin strips. In some embodiments, longitudinally-extending cantilever spring elements 508 are circular rods. Cantilever spring elements 508 may be metallic or another material with suitable elastic properties. The material composition, physical dimensions, cross-sectional shape, angular spacing, number and/or the like of the cantilever spring elements 508 may be selected to tune elastic member 504 to the desired (equation (1)) torsional stiffness kₜ while also ensuring the working stress is not undesirably high. Hub 102, spokes 507A, hub-coupling ring 506 and housing-coupling ring 510 may be significantly stiffer than the cantilever spring elements (longitudinally-extending elastic members) 508 so as to ensure low working stresses in these stiffer components. For example, the stiffness of hub 102, spokes 507A, hub coupling ring 506 and housing coupling ring 510 may be 10 times or 100 times higher than the stiffness of the cantilever spring elements 508. In other respects, vibration absorber 500 of FIG. 12 is similar to vibration absorbers 100, 200 of FIGS. 8, 9A and, except where the context dictates otherwise, discussion herein relating to vibration absorbers 100, 200 of FIGS. 8, 9A should be considered to apply to vibration absorber 500.

FIG. 13 is a perspective view of a vibration absorber 600 comprising a tube-type damper 10 and one or more elastic members 604 for tuning tube-type damper 10 according to a particular embodiment with a portion of tube-type damper 10 removed. Elastic member(s) 604 of the FIG. 13 embodiment comprise a plurality of circumferentially-oriented coil springs 616 extending between hub 102 (hidden behind housing 12 in the FIG. 14 view) and housing 12 of tube-type damper 10. In some respects, vibration absorber 600 is similar to vibration absorber 500 described above. In particular, vibration absorber 600 comprises a hub-coupling ring (hub-coupling member) 606 mounted to hub 102 and a housing-coupling ring (housing-coupling member) 610 mounted to housing 12. Hub-coupling ring 606 is connected to hub 102 at a location that is spaced apart longitudinally from the location that housing-coupling ring 610 is connected to housing 12. Vibration absorber 600 also comprises a plurality of hub arms 612 (only one of which is visible in FIG. 14) that extend longitudinally (in direction 13 or with directional components in longitudinal direction 13) from hub-coupling ring 606 toward housing-coupling ring 610. Housing-coupling ring 610 comprises a plurality of housing arms 614 (only one of which is visible in FIG. 14) that extend longitudinally (in direction 13 or with directional components in longitudinal direction 13) from housing coupling ring 610 toward hub-coupling ring 606. Hub arms 612 alternate circumferentially with housing arms 614, such that each housing arm 614 is circumferentially located between circumferentially adjacent hub arms 612 and vice versa. One or more circumferentially oriented coil springs 616 (only one of which is visible in FIG. 14) couple each housing arm 614 to circumferentially adjacent hub arms 606.

In summary, the invention provides apparatus comprising elastic members for tuning tube-type torsional viscous dampers to improve the ability of the tube-type damper to reduce problematic torsional vibrations. The torsional stiffness of the elastic members is selected, as shown in the exemplary embodiments described above, to meet the equation (1) design criteria.

Those of skill in the art will appreciate that a variety of means are described for tuning a torsional viscous damper of the tube-type in order to improve its ability to reduce problematic torsional vibrations. The torsional stiffness k_{T} of the hub-to-housing connection can be arranged as described herein to satisfy this relationship between the frequency ω₁₁ to be removed and the polar moment of inertia J of the stated housing and damper assembly.

### Interpretation of Terms

Unless the context clearly requires otherwise, throughout the description and the claims:
“connected”, “coupled”, or any variant thereof, means any connection or coupling, either direct or indirect, between two or more elements;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a hub, assembly, assembly, shaft, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

### Aspects of the Invention

The invention has a number of non-limiting aspects. Non-limiting aspects of the invention include, without limitation:

1. A vibration absorber apparatus for a mechanical system comprising a rotating machine part, the vibration absorber apparatus comprising:
a tube-type torsional damper that is attached, by a hub, to the rotating machine part for rotation with the machine part about an axis of rotation, the tube-type torsional damper having a housing that is spaced apart radially from the axis, that extends circumferentially around the axis and that has a longitudinal extension having a dimension L in a longitudinal direction parallel to the axis;
at least one elastic member connecting the hub to the housing for tuning the tube-type torsional damper;
wherein the at least one elastic member has an effective torsional stiffness k_{T} given by k_{T}=(ω₁₁)²J, where J is an overall polar moment of inertia of the tube-type torsional damper and ω₁₁ is a resonant frequency of the mechanical system.

2. The apparatus of aspect 1 or any other aspect herein wherein the at least one elastic member comprises a disc-shaped member that extends around the axis and is disposed between, and connected to, the hub and the housing.

3. The apparatus of aspect 2 or any other aspect herein wherein the disc-shaped member is shaped to define a plurality of cut-outs, the plurality of cut-outs having the same shape, equally sized, equally radially spaced apart from the axis and equally angularly spaced apart from one another about the axis.

4. The apparatus of aspect 3 or any other aspect herein wherein the disc-shaped member is shaped to define a second plurality of cut-outs, the second plurality of cut-outs having the same shape, equally sized, equally radially spaced apart from the axis and equally angularly spaced apart from one another about the axis.

5. The apparatus of aspect 4 or any other aspect herein wherein the second plurality of cut-outs has a size that is different from that of the plurality of cut-outs.

6. The apparatus of any one of aspects 4 and 5 or any other aspect herein wherein the second plurality of cut-outs has a shape that is different from that of the plurality of cut-outs.

7. The apparatus of any one of aspects 4 to 6 or any other aspect herein wherein the angular spacing between the second plurality of cut-outs is different than the angular spacing between the plurality of cut-outs.

8. The apparatus of any one of aspects 4 to 7 or any other aspect herein wherein the radial spacing from the axis of the second plurality of cut-outs is different than the radial spacing from the axis of the plurality of cut-outs.

9. The apparatus of any one of aspects 2 to 8 or any other aspect herein wherein the at least one elastic member comprises a plurality of disc-shaped members, each disc-shaped member extending around the axis and disposed between, and connected to, the hub and the housing.

10. The apparatus of aspect 9 or any other aspect herein wherein the plurality of disc-shaped members are spaced apart from one another in the longitudinal direction.

11. The apparatus of aspect 10 or any other aspect herein wherein a spacing in the longitudinal direction between an adjacent pair of the plurality of disc-shaped members is less than the dimension L of the housing in the longitudinal direction.

12. The apparatus of any one of aspects 9 to 11 or any other aspect herein wherein the plurality of disc-shaped members are identical to one other.

13. The apparatus of aspect 2 or any other aspect herein wherein the disc-shaped member is shaped to define one or more cut-outs with a spiral shape about the axis.

14. The apparatus of any one of aspects 1 to 13 or any other aspect herein wherein the at least one elastic member comprises a plurality of spokes that are angularly spaced apart from one another about the axis and that extend between, and are connected to, the hub and the housing.

15. The apparatus of aspect 14 or any other aspect herein wherein each of the plurality of spokes extends in a radial direction relative to the axis from the hub to the housing.

16. The apparatus of any one of aspects 14 to 15 or any other aspect herein wherein the spokes are removably connected to the hub and to the housing.

17. The apparatus of any one of aspects 14 to 16 or any other aspect herein wherein the spokes have dimensions in the longitudinal direction that are at least five times their arcuate dimension about the axis.

18. The apparatus of any one of aspects 14 to 17 or any other aspect herein wherein the spokes have a serpentine shape as they extend between the hub and the housing.

19. The apparatus of any one of aspects 14 to 18 or any other aspect herein wherein the at least one elastic member comprises a second plurality of spokes that are angularly spaced apart from one another about the axis and that extend between, and are connected to, the hub and the housing.

20. The apparatus of aspect 19 or any other aspect herein wherein the second plurality of spokes is spaced apart from the plurality of spokes in the longitudinal direction.

21. The apparatus of any one of aspects 19 to 20 or any other aspect herein wherein the plurality of spokes and the second plurality of spokes are identical.

22. The apparatus of aspect 1 or any other aspect herein wherein the at least one elastic member is shaped to connect to the hub and to the housing at locations that are spaced apart in the longitudinal direction from one another.

23. The apparatus of aspect 22 or any other aspect herein wherein the at least one elastic member comprises:
one or more hub-coupling members connected to the hub at a first longitudinal direction location;
one or more housing-coupling members connected to the housing at a second longitudinal direction location that is spaced apart in the longitudinal direction from the first longitudinal direction location; and
a plurality of longitudinally-extending elastic members that extend between, and are connected to, the one or more hub-coupling members and the one or more housing-coupling members.

24. The apparatus of aspect 23 or any other aspect herein wherein the plurality of longitudinally-extending elastic members extend in longitudinal directions between the one or more hub-coupling members and the one or more housing-coupling members.

25. The apparatus of any one of aspects 23 to 24 or any other aspect herein wherein a torsional stiffness of the one or more hub-coupling members is at least 10 times a torsional stiffness of the plurality of second elastic members.

26. The apparatus of any one of aspects 23 to 25 or any other aspect herein wherein a torsional stiffness of the one or more housing-coupling members is at least 10 times a torsional stiffness of the plurality of second elastic members.

27. The apparatus of any one of aspects 23 to 26 or any other aspect herein wherein the one or more hub-coupling members comprise a plurality of spokes that are angularly spaced apart from one another about the axis and that extend from the hub in directions that have a directional component that is radial relative to the axis.

28. The apparatus of aspect 27 or any other aspect herein wherein each of the plurality of longitudinally-extending elastic members are connected to a corresponding one of the spokes at a location that is spaced apart from the hub in a radial direction relative to the axis.

29. The apparatus of aspect 27 or any other aspect herein wherein the one or more hub-coupling members comprise a hub-coupling ring that extends around the axis at a location that is spaced apart from the hub in a radial direction relative to the axis.

30. The apparatus of aspect 29 or any other aspect herein wherein each of the plurality of longitudinally-extending elastic members are connected to the hub-coupling ring at a location that is spaced apart from the hub in a radial direction relative to the axis.

31. The apparatus of any one of aspects 23 to 26 or any other aspect herein wherein the one or more hub-coupling members comprise a disc-shaped member that extends from the hub in radial directions relative to the axis.

32. The apparatus of any one of aspects 23 to 31 or any other aspect herein wherein the one or more housing-coupling members comprise a housing-coupling ring that extends around the axis at a location that is spaced apart from the axis in a radial direction.

33. The apparatus of aspect 22 or any other aspect herein wherein the at least one elastic member comprises:
one or more hub-coupling members connected to the hub at a first longitudinal direction location;
one or more housing-coupling members connected to the housing at a second longitudinal direction location that is spaced apart in the longitudinal direction from the first longitudinal direction location;
the one or more hub-coupling members comprising a plurality of hub arms extending from the first longitudinal direction location in a first longitudinal direction, the plurality of hub arms equally angularly spaced apart from one another about the axis;
the one or more housing-coupling members comprising a plurality of housing arms extending from the second longitudinal direction location in in a second longitudinal direction, the second longitudinal direction opposed to the first longitudinal direction, the plurality of housing arms equally angularly spaced apart from one another about the axis and wherein each housing arm is located at an angular location about the axis that is between a pair of hub arms; and
a plurality of coil springs that extend in arcuate directions about the axis, each coil spring extending between a corresponding one of the plurality of hub arms and a corresponding one of the of the plurality of housing arms.

34. The apparatus of aspect 33 or any other aspect herein wherein a torsional stiffness of the one or more hub-coupling members is at least 10 times a torsional stiffness of the plurality of coil springs.

35. The apparatus of any one of aspects 33 to 34 or any other aspect herein wherein a torsional stiffness of the one or more housing-coupling members is at least 10 times a torsional stiffness of the plurality of coil springs.

36. The apparatus of any one of aspects 33 to 35 or any other aspect herein wherein the one or more hub-coupling members comprise a plurality of spokes that are angularly spaced apart from one another about the axis and that extend from the hub in directions that have a directional component that is radial relative to the axis.

37. The apparatus of aspect 36 or any other aspect herein wherein each of the plurality of hub arms are connected to a corresponding one of the spokes at a location that is spaced apart from the hub in a radial direction relative to the axis.

38. The apparatus of aspect 36 or any other aspect herein wherein the one or more hub-coupling members comprise a hub-coupling ring that extends around the axis at a location that is spaced apart from the hub in a radial direction relative to the axis.

39. The apparatus of aspect 38 or any other aspect herein wherein each of the plurality of hub arms are connected to the hub-coupling ring at a location that is spaced apart from the hub in a radial direction relative to the axis.

40. The apparatus of any one of aspects 33 to 35 or any other aspect herein wherein the one or more hub-coupling members comprise a disc-shaped member that extends from the hub in radial directions relative to the axis.

41. The apparatus of any one of aspects 33 to 40 or any other aspect herein wherein the one or more housing-coupling members comprise a housing-coupling ring that extends around the axis at a location that is spaced apart from the axis in a radial direction.

42. A vibration absorber apparatus for a mechanical system comprising a rotating machine part, the vibration absorber apparatus comprising:
a tube-type torsional damper that is attached, by a hub, to the rotating machine part for rotation with the machine part about an axis of rotation, the tube-type torsional damper having a housing that is spaced apart radially from the axis, that extends circumferentially around the axis and that has a longitudinal extension having a dimension L in a longitudinal direction parallel to the axis;
at least one elastic member connecting the hub to the housing for tuning the tube-type torsional damper;
the at least one elastic member shaped to connect to the hub and to the housing at locations that are spaced apart in the longitudinal direction from one another.

43. The apparatus of aspect 42 or any other aspect herein wherein the at least one elastic member comprises:
one or more hub-coupling members connected to the hub at a first longitudinal direction location;
one or more housing-coupling members connected to the housing at a second longitudinal direction location that is spaced apart in the longitudinal direction from the first longitudinal direction location; and
a plurality of longitudinally-extending elastic members that extend between, and are connected to, the one or more hub-coupling members and the one or more housing-coupling members.

44. The apparatus of aspect 43 or any other aspect herein wherein the plurality of longitudinally-extending elastic members extend in longitudinal directions between the one or more hub-coupling members and the one or more housing-coupling members.

45. The apparatus of any one of aspects 43 to 44 or any other aspect herein wherein a torsional stiffness of the one or more hub-coupling members is at least 10 times a torsional stiffness of the plurality of longitudinally-extending elastic members.

46. The apparatus of any one of aspects 43 to 45 or any other aspect herein wherein a torsional stiffness of the one or more housing-coupling members is at least 10 times a torsional stiffness of the plurality of longitudinally-extending elastic members.

47. The apparatus of any one of aspects 43 to 46 or any other aspect herein wherein the one or more hub-coupling members comprise a plurality of spokes that are angularly spaced apart from one another about the axis and that extend from the hub in directions that have a directional component that is radial relative to the axis.

48. The apparatus of aspect 47 or any other aspect herein wherein each of the plurality of longitudinally-extending elastic members are connected to a corresponding one of the spokes at a location that is spaced apart from the hub in a radial direction relative to the axis.

49. The apparatus of aspect 47 or any other aspect herein wherein the one or more hub-coupling members comprise a hub-coupling ring that extends around the axis at a location that is spaced apart from the hub in a radial direction relative to the axis.

50. The apparatus of aspect 49 or any other aspect herein wherein each of the plurality of longitudinally-extending elastic members are connected to the hub-coupling ring at a location that is spaced apart from the hub in a radial direction relative to the axis.

51. The apparatus of any one of aspects 43 to 46 or any other aspect herein wherein the one or more hub-coupling members comprise a disc-shaped member that extends from the hub in radial directions relative to the axis.

52. The apparatus of any one of aspects 43 to 51 or any other aspect herein wherein the one or more housing-coupling members comprise a housing-coupling ring that extends around the axis at a location that is spaced apart from the axis in a radial direction.

53. A method for damping vibrations in a mechanical system comprising a rotating machine part, the method comprising:
providing a tube-type torsional damper that is attached, by a hub, to the rotating machine part for rotation with the machine part about an axis of rotation, the tube-type torsional damper having a housing that is spaced apart radially from the axis, that extends circumferentially around the axis and that has a longitudinal extension having a dimension L in a longitudinal direction parallel to the axis;
connecting at least one elastic member to the hub and to the housing;
wherein the at least one elastic member has an effective torsional stiffness k_{T} given by k_{T}=(ω₁₁)²J, where J is an overall polar moment of inertia of the tube-type torsional damper and ω₁₁ is a resonant frequency of the mechanical system.

54. The method of aspect 53 comprising method features corresponding to the features of any of aspects 1 to 51.

55. A method for damping vibrations in a mechanical system comprising a rotating machine part, the method comprising:
providing a tube-type torsional damper that is attached, by a hub, to the rotating machine part for rotation with the machine part about an axis of rotation, the tube-type torsional damper having a housing that is spaced apart from the axis, that extends circumferentially around the axis and that has a longitudinal extension having a dimension L in a longitudinal direction parallel to the axis;
connecting at least one elastic member to the hub and to the housing;
wherein connecting the at least one elastic member to the hub and to the housing comprises connecting the at least one elastic member to the hub and to the housing at locations that are spaced apart in the longitudinal direction from one another.

56. The method of aspect 55 comprising method features corresponding to the features of any of aspects 1 to 51.

57. Apparatus comprising any features, combinations of features and/or sub-combinations of features disclosed herein.

58. Methods comprising any features, combinations of features and/or sub-combinations of features disclosed herein.

What is claimed is:

1. A vibration absorber apparatus for a mechanical system comprising a rotating machine part, the vibration absorber apparatus comprising:
a tube-type torsional damper that is attached, by a hub, to the rotating machine part for rotation with the machine part about an axis of rotation, the tube-type torsional damper having a housing that is spaced apart radially from the axis, that extends circumferentially around the axis and that has a longitudinal extension having a dimension L in a longitudinal direction parallel to the axis;
at least one elastic member connecting the hub to the housing for tuning the tube-type torsional damper;
wherein the at least one elastic member has an effective torsional stiffness k_{T} given by k_{T}=(ω₁₁)²J, where J is an overall polar moment of inertia of the tube-type torsional damper and ω₁₁ is a resonant frequency of the mechanical system.

2. The apparatus of claim 1 wherein the at least one elastic member comprises a disc-shaped member that extends around the axis and is disposed between, and connected to, the hub and the housing.

3. The apparatus of claim 2 wherein the disc-shaped member is shaped to define a plurality of cut-outs, the plurality of cut-outs having the same shape, equally sized, equally radially spaced apart from the axis and equally angularly spaced apart from one another about the axis.

4. The apparatus of claim 3 wherein the disc-shaped member is shaped to define a second plurality of cut-outs, the second plurality of cut-outs having the same shape, equally sized, equally radially spaced apart from the axis and equally angularly spaced apart from one another about the axis.

5. The apparatus of claim 4 wherein the second plurality of cut-outs has a size that is different from that of the plurality of cut-outs.

6. The apparatus of claim 4 wherein the second plurality of cut-outs has a shape that is different from that of the plurality of cut-outs.

7. The apparatus of claim 4 wherein the angular spacing between the second plurality of cut-outs is different than the angular spacing between the plurality of cut-outs.

8. The apparatus of claim 4 wherein the radial spacing from the axis of the second plurality of cut-outs is different than the radial spacing from the axis of the plurality of cut-outs.

9. The apparatus of claim 2 wherein the at least one elastic member comprises a plurality of disc-shaped members, each disc-shaped member extending around the axis and disposed between, and connected to, the hub and the housing.

10. The apparatus of claim 9 wherein the plurality of disc-shaped members are spaced apart from one another in the longitudinal direction.

11. The apparatus of claim 10 wherein a spacing in the longitudinal direction between an adjacent pair of the plurality of disc-shaped members is less than the dimension L of the housing in the longitudinal direction.

12. The apparatus of claim 9 wherein the plurality of disc-shaped members are identical to one other.

13. The apparatus of claim 2 wherein the disc-shaped member is shaped to define one or more cut-outs with a spiral shape about the axis.

14. The apparatus of claim 1 wherein the at least one elastic member comprises a plurality of spokes that are angularly spaced apart from one another about the axis and that extend between, and are connected to, the hub and the housing.

15. The apparatus of claim 14 wherein each of the plurality of spokes extends in a radial direction relative to the axis from the hub to the housing.

16. The apparatus of claim 14 wherein the spokes are removably connected to the hub and to the housing.

17. The apparatus of claim 14 wherein the spokes have dimensions in the longitudinal direction that are at least five times their arcuate dimension about the axis.

18. The apparatus of claim 14 wherein the spokes have a serpentine shape as they extend between the hub and the housing.

19. The apparatus of claim 14 wherein the at least one elastic member comprises a second plurality of spokes that are angularly spaced apart from one another about the axis and that extend between, and are connected to, the hub and the housing.

20. The apparatus of claim 19 wherein the second plurality of spokes is spaced apart from the plurality of spokes in the longitudinal direction.
